(19) United States
(12) Patent Application Publication
(10) Pub. No.: US 2021/0388555 A1
(43) Pub. Date: Dec. 16, 2021

(54) LAUNDRY TREATING APPARATUS

(71) Applicant: LG Electronics Inc., Seoul (KR)

(72) Inventors: Jihong Lee, Seoul (KR); Kyoungmin Choi, Seoul (KR); Kwan Woong Jeong, Seoul (KR)

(73) Assignee: LG Electronics Inc., Seoul (KR)

(21) Appl. No.: 17/284,424

(22) PCT Filed: Oct. 11, 2019
(86) PCT No.: PCT/KR2019/013347

§ 371 Date: Apr. 9, 2021

(30) Foreign Application Priority Data
Oct. 11, 2018 (KR) 10-2018-0121113

(51) Int. Cl. D06F 39/12; D06F 37/12; D06F 37/30; D06F 37/24

(52) U.S. Cl. CPC D06F 39/12; D06F 37/24; D06F 37/30; D06F 37/12

(57) ABSTRACT

A laundry treating apparatus includes a cabinet with an outlet, a drawer drawn out from the outlet, a drum provided inside the drawer, providing a space where laundry is stored, a base fixed to the cabinet, a base slit provided in the base, including a linear portion and a first bent portion, a slider coupled to the base to move along the base, a slider slit, a conveyer, an operation unit fixed to the drawer and detachably coupled to the conveyer, and springs provided to connect the base with the slider and provided to move the slider toward a rear end of the linear portion if the conveyer moves from the first bent portion to the linear portion.

### TECHNICAL FIELD

The present disclosure relates to a laundry treating apparatus.

### BACKGROUND

Generally, a laundry treating apparatus includes an apparatus for washing laundry (washing targets), an apparatus for drying laundry (drying targets), and an apparatus for performing both washing and drying laundry.

Laundry treating apparatuses of the related art are categorized into a front loading type laundry treating apparatus having a laundry inlet provided on a front surface to load laundry therein and a top loading type laundry treating apparatus having a laundry inlet provided on an upper surface to load laundry therein. An example of the top loading type laundry treating apparatus includes a drawer type laundry treating apparatus that includes a cabinet, a drawer capable of being drawn out from the cabinet, and a storage provided in the drawer to store laundry.

The drawer type laundry treating apparatus may draw out the drawer from the cabinet or insert the drawer into the cabinet by supplying an external force to the drawer. In the drawer type laundry treating apparatus of the related art, a risk may occur in that the drawer may be drawn out from the cabinet by vibration generated during operation of the laundry treating apparatus even though a user does not apply an external force to the drawer.

### SUMMARY

### Technical Problem

Accordingly, the present disclosure is directed to a laundry treating apparatus that substantially obviates one or more problems due to limitations and disadvantages of the related art. An object of the present disclosure is to provide a laundry treating apparatus that can allow a drawer to be drawn out from a cabinet only if an external force of a predetermined size or more is input to the drawer by supplying a force for maintaining a pressurized state of the drawer toward the inside of the cabinet to the drawer.

### Technical Solution

The present disclosure provides a laundry treating apparatus comprising a cabinet provided with an outlet; a drawer provided to be drawn out from the cabinet through the outlet; a drum provided inside the drawer, providing a space where laundry is stored; a base fixed to the cabinet; a base slit provided in the base, including a linear portion parallel with a moving direction of the drawer and a first bent portion connected to a front end of the linear portion located in a drawing direction of the drawer; a slider coupled to the base to move along the base; a slider slit provided to pass through the slider; a conveyer (a transfer part) having one end movably coupled to the base slit and the other end inserted into the slider slit and moving along the base slit during movement of the slider; an operation unit fixed to the drawer and detachably coupled to the conveyer, moving the conveyer from the linear portion to the first bent portion when the drawer moves toward the drawing direction from the cabinet, and moving the conveyer from the first bent portion to the linear portion when the drawer moves toward an insertion direction into the cabinet; and a spring provided to connect the base with the slider and provided to move the slider toward a rear end of the linear portion when the conveyer moves from the first bent portion to the linear portion.

The laundry treating apparatus of the present disclosure may further comprise a first rail provided at a point higher than the base slit in a space provided by the base, a second rail provided at a point lower than the base slit in the space provided by the base, a first rail holder provided in the slider and coupled to the first rail, and a second rail holder provided in the slider and coupled to the second rail.

The slider slit may be provided along a direction crossing the linear portion.

The first bent portion may be bent toward the point higher than the linear portion at the front end of the linear portion, the operation unit may include an operation body fixed to the drawer, and a conveyer guide provided in the operation body, providing a moving path of the conveyer, and the conveyer guide may include an insertion hole provided at a position into which the conveyer located at the first bent portion is inserted, and an inclined portion provided to be downwardly inclined from the insertion hole, moving the conveyer entering the insertion hole from the first bent portion to the linear portion.

The spring may be provided at a tensile state even in the case that the conveyer is located at the rear end of the linear portion.

The laundry treating apparatus of the present disclosure may further comprise a second bent portion bent toward a point lower than the linear portion at the rear end of the linear portion, wherein the first bent portion may be bent toward the point higher than the linear portion at the front end of the linear portion.

The operation unit may include an operation body fixed to the drawer, and a conveyer guide provided in the operation body, providing a moving path of the conveyer, and the conveyer guide may include an insertion hole provided at a position into which the conveyer located at the first bent portion is inserted, and an inclined portion provided to be downwardly inclined from the insertion hole, moving the conveyer entering the insertion hole to the second bent portion.

The spring may be provided to be maintained at a tensile state even in the case that the conveyer is inserted into the second bent portion.

The laundry treating apparatus of the present disclosure may further comprise a preload supply unit for pressurizing the slider toward the rear end of the linear portion.

A section (An interval) where the slider is supplied with a force from the spring and a section (an interval) where the slider is provided with a force from the pre-load supply unit may be provided to be overlapped with each other.

The pre-load supply unit may include a permanent magnet fixed to any one of the base and the slider, and a conductor fixed to the other one of the base and the slider.

### Advantageous Effects

According to the present disclosure, a laundry treating apparatus is provided, which can allow a drawer to be drawn out from a cabinet only if an external force of a predetermined size or more is input to the drawer by supplying a force for maintaining a pressurized state of the drawer toward the inside of the cabinet to the drawer.

### BRIEF DESCRIPTION OF DRAWINGS

FIGS. 1 and 2 illustrate an example of a laundry treating apparatus.

FIGS. 3 and 4 illustrate an example of a position controller provided in a laundry treating apparatus.

FIGS. 5 (a) and (b) illustrates operation processes of a position controller.

FIGS. 6 (a) and (b) illustrate other examples of a position controller.

### DETAILED DESCRIPTION

Hereinafter, preferred embodiments of a laundry treating apparatus will be described in detail with reference to the accompanying drawings.

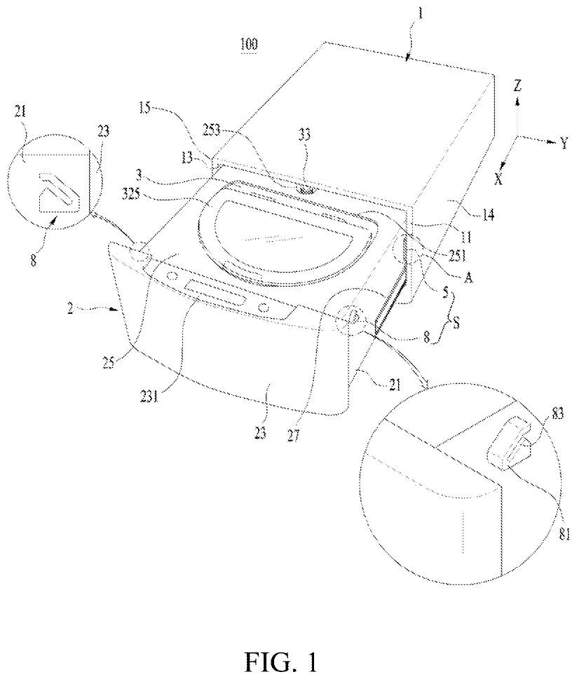

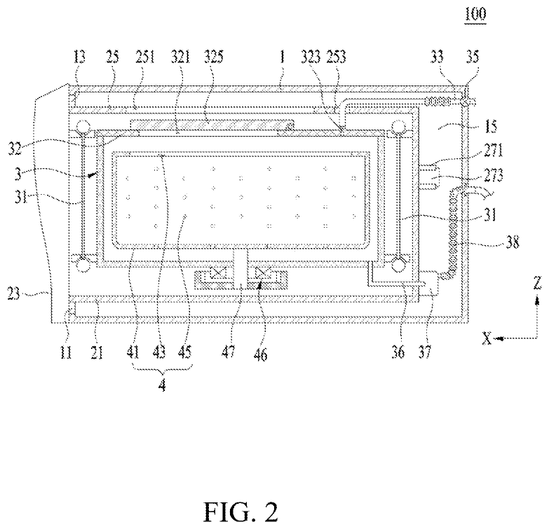

FIGS. 1 and 2 illustrate an example of a laundry treating apparatus 100. The laundry treating apparatus 100 of the present disclosure includes a cabinet 1 provided with an outlet 13 on a front surface 11, a drawer 2 located inside the cabinet 1, capable of being drawn out from the cabinet through the outlet 13, a tub 3 provided inside the drawer 2, storing water therein, and a drum 4 rotatably provided inside the tub, storing laundry therein.

The drawer 2 may include a drawer body 21 located in the cabinet 1, a drawer panel 23 fixed to the drawer body 21, opening or closing the outlet 13 depending on a position of the drawer body, and a drawer guide 27 provided to connect the cabinet 1 with the drawer body 21 and also provided to allow the drawer body 21 to be drawn out from the cabinet or inserted into the cabinet.

The drawer body 21 may be provided in all shapes capable of being inserted into the cabinet 1 through the outlet 13. FIG. 1 illustrates that the drawer body 21 is provided in a hexahedron as an example. In this case, a first through hole 251 and a second through hole 253 are provided on an upper surface 25 (drawer cover) of the drawer body.

Since the drawer panel 23 is maintained in a state exposed to the outside of the cabinet 1, a control panel 231 may be provided in the drawer panel 23. The control panel 231 may include an input unit to which a control command from a user is input, and a display unit for displaying information related to control for the user.

The drawer guide 27 may include a first guide for connecting a first side 14 of the cabinet with a first side of the drawer body, and a second guide for connecting a second side 15 of the cabinet with a second side of the drawer body.

As shown in FIG. 2, the respective guides may include a first frame 271 fixed to the cabinet 1, and a second frame 273 coupled to the first frame 271 to be drawn out from the first frame 271 and fixed to the drawer body 21.

The tub 3 may be provided in a hollow cylindrical shape, and may be fixed to the drawer 2 through a tub support 31 that connects the rawer body 21 with a circumferential surface of the tub 3.

An inlet 321 for communicating the inside of the tub with the outside of the tub is provided on an upper surface 32 (tub cover) of the tub, wherein the inlet 321 is closed or opened by a door 325 rotatably fixed to the upper surface of the tub. Since the door 325 is located below the first through hole 251 provided in the drawer cover, the user may rotate the door 325 to be far away from the tub cover 32 through the first through hole 251.

The aforementioned tub 3 is supplied with water through a water supply, and discharges water stored therein to the outside of the cabinet through a drainage. The water supply may include a water supply pipe 33 for connecting the tub 3 with a water supply source, and a water supply valve 35 for closing or opening the water supply pipe. In this case, the tub cover 32 may be provided with a water supply hole 323 for allowing the water supplied from the water supply pipe 33 to enter the inside of the tub 4. The water supply pipe 33 may be provided as a corrugated pipe capable of being extended toward a drawing direction (X-axis direction) of the drawer.

The drainage includes a drainage pump 37 fixed to the drawer body 21, a first drainage pipe 36 for connecting the tub 3 with the drainage pump, and a second drainage pipe 38 for guiding the water discharged from the drainage pump to the outside of the cabinet. The second drainage pipe 38 may be provided as a corrugated pipe capable of passing through a point higher than the highest water level set in the tub and being elongated toward the drawing direction of the drawer.

The drum 4 may include a hollow cylindrical drum body 41, and a drum inlet 43 provided on an upper surface of the drum body to allow laundry supplied to the inlet 321 to enter the inside of the drum body. A plurality of communication holes 45 for communicating an inner space of the drum with an inner space of the drum may be provided on a circumferential surface and a bottom surface of the drum body 41.

The drum body 41 may be rotated by a driver 46, and the driver 46 may include a stator fixed to the bottom surface of the tub, a rotor rotated by a rotating magnetic field provided by the stator, and a rotary shaft for connecting the rotor with the drum body by passing through the tub.

The laundry treating apparatus may further include a position controller that provides the drawer with a force (force for moving in −X axis direction) for moving the drawer body 21 to the inside of the cabinet 1 if the drawer body 21 moves to a preset position.

The position controller may include a first position controller provided in the first die 14 of the cabinet, and a second position controller provided in the second side 15 of the cabinet, wherein the two position controllers are provided in the same structure.

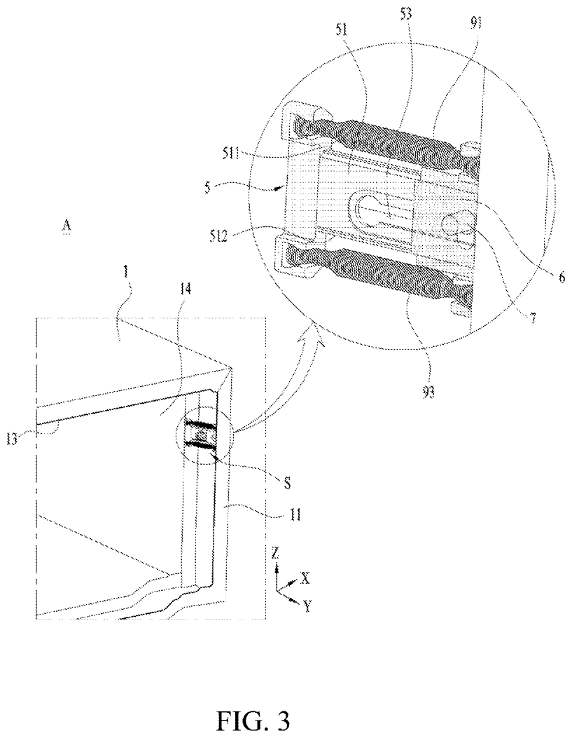

FIG. 3 illustrates an example of a first position controller S provided in the first side 14. The first position controller S includes a base 5 fixed to the first side 14 of the cabinet, a base slit 53 provided along a length direction (X-axis direction, drawing direction of the drawer) of the base, a conveyer (a carrying unit) 7 capable of moving along a path provided by the base slit 53, a slider 6 capable of reciprocating along the length direction of the base by means of the conveyer 7, and an operation unit 8 (see FIG. 1) provided at a side of the drawer body 21 and coupled to or separated from the conveyer 7 in accordance with the position of the drawer 2.

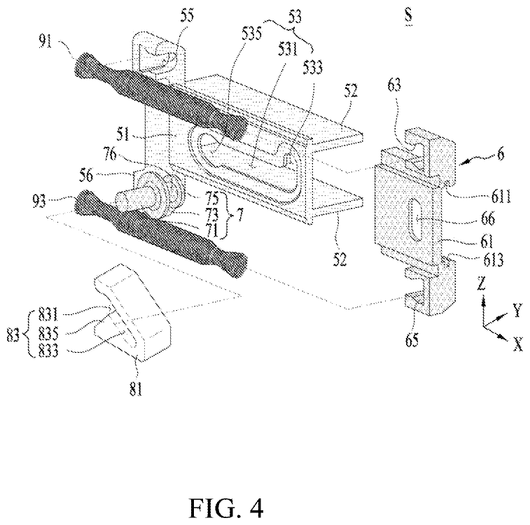

As shown in FIG. 4, the base 5 includes a base body 51 provided with the base slit 53, and a support body 52 for fixing the base body to the first side 14. The support body 52 is a space for forming a space between the base body 51 and the first side 14, wherein the space formed between the base body 51 and the first side 14 forms a space to which one end of the conveyer 7 moves. The support body 52 may include a first support body located above the base slit 53 and a second support body located below the base slit 53.

The base slit 53 is a means provided to pass through the base body 51 to provide a moving path of the conveyer 7, and may include a linear portion 531 and a first bent portion 533.

The linear portion 531 is a through hole (length is set to be longer than a diameter) provided to be parallel with a moving direction (X-axis direction) of the drawer, and the first bent portion 533 is a through hole (length is set to be longer than a diameter) inclined from a front end (one end located in a drawing direction of the drawer from both ends of the linear portion) of the linear portion toward an upper portion or a lower portion of the linear portion.

The description that the linear portion 531 is provided along the same direction as the moving direction of the drawer 2 includes a case that the linear portion 531 is parallel with the moving direction (moving direction of an operation body) of the drawer and a case that the linear portion 531 is provided to be inclined with the moving direction of the drawer.

Moreover, the base slit 53 may include a second bent portion 535 bent at a rear end of the linear portion 531 toward an opposite direction of a bent direction of the first bent portion 533. FIG. 4 illustrates that the first bent portion 533 is bent toward an upper portion of the linear portion 531 and the second bent portion 535 is bent toward a lower portion of the linear portion 531.

The base body 51 may further include first and second rails for providing a moving path of the slider 6, wherein the first rail 511 may be provided at an upper end of the base body 51 along the length direction of the base body 51 and the second rail 513 may be provided at a lower end of the base body 51 along the length direction of the base body.

The slider 6 includes a slider body 61 capable of reciprocating along the first rail 511 and the second rail 513, and a slider slit 66 provided to pass through the slider body, passing through the conveyer 7.

The slider body 61 may be provided as a plate parallel with a surface of the base body 51 provided with the base slit 53, and includes a first rail holder 611 provided at an upper end of the slider body 61 and coupled with the first rail 511, and a second rail holder 613 provided at a lower end of the slider body 61 and coupled with the second rail 513.

The first rail holder 611 may be provided in all shapes capable of moving along the first rail 511, and the second rail holder 613 may be provided in all shapes capable of moving along the second rail 513.

The slider body 61 is connected to the base body 51 through springs 91 and 93. The springs are provided to provide a force for allowing the slider 6 to move from the front (direction where the first bent portion is located) of the base body to the rear of the base body.

That is, the springs may be provided as tensile coil springs elongated when the slider 6 moves from the rear of the base body to the front of the base body. In this case, the springs may include a first spring 91 located above the first rail 511 and a second spring 93 located below the second rail 513.

One end of the first spring 91 is fixed to a first spring first clamp 55 provided on the upper end of the base body 51, and the other end of the first spring 91 is fixed to a first spring second clamp 63 provided on the upper end of the slider body 61. One end of the second spring 93 is fixed to a second spring first clamp 56 provided on the lower end of the base body 51, and the other end of the second spring 93 is fixed to a second spring second clamp 65 provided on the lower end of the slider body 61.

The slider slit 66 is a through hole provided along a direction crossing the linear portion 531, wherein a length (Z-axis direction length) of the through hole is set to be longer than a diameter (X-axis direction length). FIG. 4 illustrates that the slider slit 66 is provided along a direction (Z-axis direction) orthogonal to the moving direction of the drawer body 21, as an example.

One end of the conveyer 7 is coupled to the base slit 53 and its other end may be provided as a conveyer body 71 inserted into the slider slit 66. The conveyer body 71 may be provided as a bar shape.

One end of the conveyer body 71 is movably coupled to the base slit 53 through a first protrusion and a second protrusion 75, wherein the first protrusion 73 may be provided as a disk having a first diameter and the second protrusion 75 may be provided as a disk having a second diameter (smaller than the first diameter).

A joint groove 76 is provided between the first protrusion 73 and the second protrusion 75, and the base slit 53 is inserted into the joint groove 76. Therefore, one end of the conveyer body 71 may move along a path provided by the base slit 533. Shapes of the protrusions 73 and 75, which can embody the aforementioned function, may be provided differently from the shown shapes.

Preferably, an insertion hole (not shown) having a diameter greater than that of the second protrusion 55 and smaller than that of the first protrusion 73 is further provided at an end of the second bent portion 535 to couple one end of the conveyer body 71 to the base slit 53.

The operation unit 8 is a means for moving the conveyer body 71 located at the second bent portion 535 to the first bent portion 533 through the linear portion 531 if the drawer body 21 moves toward the drawing direction (X-axis direction) from the cabinet 1 and moving the conveyer body 71 located at the first bent portion 533 to the second bent portion 535 through the linear portion 531 if the drawer body 21 moves toward the insertion direction (−X-axis direction) into the cabinet 1.

The operation unit 8 includes an operation body 81 fixed to the first side (surface facing the first side of the cabinet) of the drawer body 21, and a conveyer guide 83 provided in the operation body 81, providing a moving path of the conveyer body 71. The conveyer guide 83 may be provided as a through hole passing through the operation body 81, or may be provided as a groove formed as the surface of the operation body is bent to be recessed. FIG. 4 illustrates that the conveyer guide 83 is provided as a through hole.

The conveyer guide 83 includes an insertion hole 831 into which the conveyer body 71 is inserted, and an inclined portion 833 provided to be downwardly inclined from the insertion hole 831.

The insertion hole 831 is provided on a surface (surface toward the direction of the drawer inserted into the cabinet) toward the conveyer body 71 among spaced provided by the operation body 81, and is a means for guiding the other end of the conveyer body 71 located in the first bent portion 533 to the inclined portion 833.

The inclined portion 833 moves one end of the conveyer body coupled to the base slit 53 from the first bent portion 533 to the linear portion 531 by moving a free end of the conveyer body 71 entering the insertion hole 831 to the direction of the lower surface of the operation body 81 (moving to a point lower than the insertion hole).

Moreover, a length of the inclined portion 833 should be set to a length of the lowest end of the inclined portion, which is located at the same height as the lowest end of the second bent portion 535, or should be set to a length of the lowest end of the inclined portion, which is located at a position lower than the lowest end of the second bent portion 535, so that the conveyer body 71 that has moved to the linear portion 531 may move to the second bent portion 535.

The operation body 81 may further be provided with a conveyer body guide 835 for guiding the free end of the conveyer body 71 to the insertion hole 831.

As described above, since the second position controller provided at the second side 15 of the cabinet may be provided in the same structure as that of the first position controller S, its structure description will be omitted.

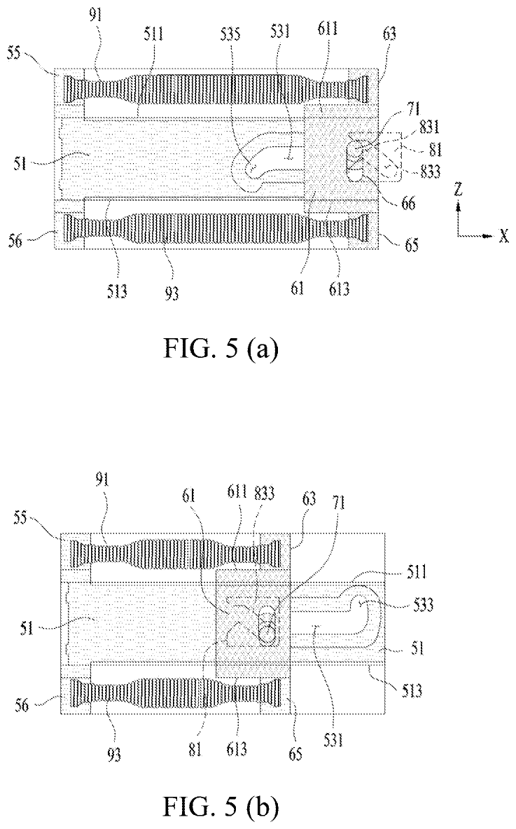

Hereinafter, the operation process of the aforementioned position controller will be described with reference to FIGS. 5 (a) and (b).

FIG. 5a illustrates the moment when the operation unit 8 is coupled to the conveyer 7 as the drawer 2 drawn out from the cabinet by an external force input by a user moves toward the inside (−X-axis) of the cabinet 1. FIG. 5b illustrates that the drawer 2 moves toward the inside of the cabinet 1 by means of the springs 91 and 93.

As shown in FIG. 5a, if the user pushes the drawer 2 toward the inside of the cabinet 1 (toward −X-axis direction), the operation unit 8 fixed to the drawer body 21 moves toward the conveyer 7. In this process, the free end of the conveyer body 71 is inserted into the inclined portion 833 through the insertion hole 831 provided in the operation body 81.

If the conveyer body 71 moves toward the lower surface of the operation body 81 along the inclined portion 833 (if the conveyer body moves to a point lower than the insertion hole along the inclined portion), the conveyer body 71 moves from the first bent portion 533 to the linear portion 531. As shown in FIG. 5b, if the conveyer body 71 moves from the first bent portion 533 to the linear portion 531, the slider body 61 will move toward the rear of the base body 51 by means of a restoring force provided by the two springs 91 and 93.

The conveyer body 71 is coupled to the slider body 61 through the slider slit 66, and is coupled to the operation body 81 through the inclined portion 833. Therefore, if the slider body 61 moves toward the rear of the base body 51, the conveyer body 71 and the operation body 81 will move toward the rear of the base body 51. In this process, the drawer body 21 will also move into the cabinet.

Therefore, in the present disclosure, if the drawer moves to a reference position (position where the conveyer body is coupled to the insertion hole) toward the inside of the cabinet, the drawer body may automatically be inserted into the cabinet even though the user does not push the drawer.

Meanwhile, the first spring 91 and the second spring 93 may be provided to be maintained at a tensile state even in the case that the conveyer body 71 is inserted into the second bent portion 535. This is to maintain the state of the drawer body 21 pressurized toward the inside of the cabinet 1. Therefore, in the present disclosure, since the drawer may be drawn out from the cabinet only if an external force of a preset size or more is input to the drawer, the drawer body 21 may be prevented from being drawn out from the cabinet by vibration generated during rotation of the drum.

If the user draws out the drawer body 21 from the cabinet 1 in the state of FIG. 5b, the operation body 81 fixed to the drawer body 21 will move toward the front of the base body 51 (move in X-axis direction).

If the operation body 81 moves toward the front of the base body, the free end of the conveyer body 71 inserted into the inclined portion 833 moves toward the insertion hole 831. In this process, the conveyer body 71 moves from the second bent portion 535 to the linear portion 531.

If the conveyer body 71 moves toward the front of the base body 51 along the linear portion 531, the slider body 61 moves toward the front of the base body by means of the conveyer body 71.

If the conveyer body 71 moves from the linear portion 531 to the first bent portion 533, since the free end of the conveyer body 71 is drawn out from the inclined portion 833 through the insertion hole 831, the conveyer body 71 is detached from the operation body 81. If the operation body 81 is detached from the conveyer body 71, the drawer body 21 may be drawn out from the cabinet until the door 325 is exposed to the outside of the cabinet.

The first bent portion 533 is provided in a shape bent from the front end of the linear portion 531 toward the upper portion. Therefore, if the conveyer body 71 moves from the linear portion 531 to the first bent portion 533, the conveyer body 71 cannot move from the first bent portion 533 to the linear portion 531 without external force. This means that the position of the slider body 61 is fixed if the conveyer body 71 is inserted into the first bent portion 533, and the first spring 91 and the second spring 93 are maintained at the tensile state.

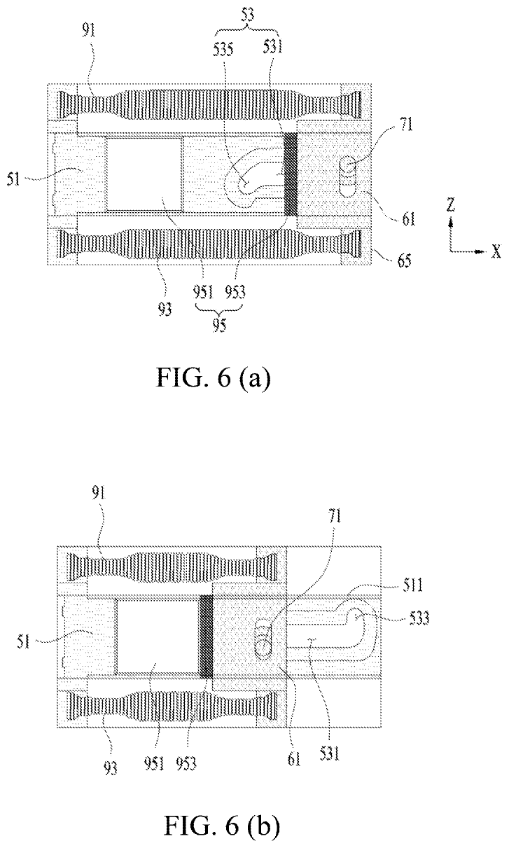

FIGS. 6 (a) and (b) illustrate examples of a position controller provided in the present disclosure. The position controller according to this embodiment further includes a preload supply unit.

The pre-load supply unit 95 is a means for providing a force for moving the slider body 61 to the rear of the base body 51, and may include a permanent magnet 951 fixed to any one of the base body 51 and the slider body 61, and a magnetic body 953 fixed to the other one of the base body 51 and the slider body 61. FIG. 6 illustrates that the permanent magnet 951 is fixed to the base body 51 and the magnetic body 953 is fixed to the slider body 61, as an example.

Unlike the shown case, the pre-load supply unit 95 may be provided with a first permanent magnet fixed to the base body 51, and a second permanent magnet provided in the slider body 61, providing attraction to the first permanent magnet.

Moreover, an interval (a section) where the slider body 61 is supplied with a force from the springs 91 and 93 and an interval (a section) where the slider body 61 is provided with a force from the pre-load supply unit 95 may be provided to be overlapped with each other. In this case, the drawer body 21 may be prevented from being drawn out from the cabinet by vibration generated during rotation of the drum more effectively.

Although the aforementioned position controller has been described based on that the base 5, the conveyer 7 and the slider 6 are provided in the cabinet 1 and the operation unit 8 is provided in the drawer body 21, unlike the shown case, the position controller may be provided in such a manner that the operation unit 8 is provided at the first side 14 of the cabinet and the base 5, the conveyer 7 and the slider 6 are provided in the drawer body 21.

It will be apparent to those skilled in the art that the present disclosure may be embodied in other specific forms without departing from the spirit and essential characteristics of the disclosure. Thus, the above embodiments are to be considered in all respects as illustrative and not restrictive. The scope of the disclosure should be determined by reasonable interpretation of the appended claims and all change which comes within the equivalent scope of the disclosure are included in the scope of the disclosure.

What is claimed is:

1. A laundry treating apparatus comprising:
a cabinet provided with an outlet;
a drawer provided to be drawn out from the cabinet through the outlet;
a drum provided inside the drawer, providing a space where laundry is stored;
a base fixed to the cabinet;
a base slit provided in the base, including a linear portion parallel with a moving direction of the drawer and a first bent portion connected to a front end of the linear portion located in a drawing direction of the drawer;
a slider coupled to the base to move along the base;
a slider slit provided to pass through the slider;
a conveyer having one end movably coupled to the base slit and the other end inserted into the slider slit and moving along the base slit during movement of the slider;
an operation unit fixed to the drawer and detachably coupled to the conveyer, moving the conveyer from the linear portion to the first bent portion when the drawer moves toward the drawing direction from the cabinet, and moving the conveyer from the first bent portion to the linear portion when the drawer moves toward an insertion direction into the cabinet; and
a spring provided to connect the base with the slider and provided to move the slider toward a rear end of the linear portion when the conveyer moves from the first bent portion to the linear portion.

2. The laundry treating apparatus of claim 1, further comprising:
a first rail provided at a point higher than the base slit in a space provided by the base;
a second rail provided at a point lower than the base slit in the space provided by the base;
a first rail holder provided in the slider and coupled to the first rail; and
a second rail holder provided in the slider and coupled to the second rail.

3. The laundry treating apparatus of claim 2, wherein the slider slit is provided along a direction crossing the linear portion.

4. The laundry treating apparatus of claim 3, wherein the first bent portion is bent toward the point higher than the linear portion at the front end of the linear portion, the operation unit includes an operation body fixed to the drawer, and a conveyer guide provided in the operation body, providing a moving path of the conveyer, and the conveyer guide includes an insertion hole provided at a position into which the conveyer located at the first bent portion is inserted, and an inclined portion provided to be downwardly inclined from the insertion hole, moving the conveyer entering the insertion hole from the first bent portion to the linear portion.

5. The laundry treating apparatus of claim 3, wherein the spring is provided to be maintained at a tensile state even in the case that the conveyer is located at the rear end of the linear portion.

6. The laundry treating apparatus of claim 3, further comprising a second bent portion bent toward a point lower than the linear portion at the rear end of the linear portion, wherein the first bent portion is bent toward the point higher than the linear portion at the front end of the linear portion.

7. The laundry treating apparatus of claim 6, wherein the operation unit includes an operation body fixed to the drawer, and a conveyer guide provided in the operation body, providing a moving path of the conveyer, and the conveyer guide includes an insertion hole provided at a position into which the conveyer located at the first bent portion is inserted, and an inclined portion provided to be downwardly inclined from the insertion hole, moving the conveyer entering the insertion hole to the second bent portion.

8. The laundry treating apparatus of claim 7, wherein the spring is provided to be maintained at a tensile state even in the case that the conveyer is inserted into the second bent portion.

9. The laundry treating apparatus of claim 8, further comprising a pre-load supply unit for pressurizing the slider toward the rear end of the linear portion.

10. The laundry treating apparatus of claim 9, wherein a section where the slider is supplied with a force from the spring and a section where the slider is provided with a force from the pre-load supply unit are provided to be overlapped with each other.

11. The laundry treating apparatus of claim 10, wherein the pre-load supply unit includes:
a permanent magnet fixed to any one of the base and the slider; and a conductor fixed to the other one of the base and the slider.
